(19) United States
(12) Patent Application Publication
(10) Pub. No.: US 2022/0222083 A1
(43) Pub. Date: Jul. 14, 2022

(54) LIGHTWEIGHT EXTENDS

(71) Applicant: Google LLC, Mountain View, CA (US)

(72) Inventors: Lloyd Tabb, Santa Cruz, CA (US); Michael Toy, Los Altos, CA (US); Aryeh Hillman, Mountain View, CA (US); Steven Talbot, Santa Cruz, CA (US); Kevin F. McCarthy, Mountain View, CA (US)

(73) Assignee: Google LLC, Mountain View, CA (US)

(21) Appl. No.: 17/145,698

(22) Filed: Jan. 11, 2021

(51) Int. Cl. G06F 9/445; G06F 30/20

(52) U.S. Cl. CPC G06F 9/445; G06F 2111/16; G06F 30/20

(57) ABSTRACT

A method for the lightweight extension of a data model includes first loading into memory, an extension document referencing a model document in a data analytics system. The model document defines a data model and the extension document extends the data model with at least one modification to the data model. The method then includes extracting from the extension document, the modification to the data model. Finally, the method includes creating in the memory the data model from the model document combined with the modification so as to produce an extension to the data model without processing a redeclaration of a view of the data model in the extension document.

### TECHNICAL FIELD

The present disclosure relates to the field of data analytics and more particularly to the extension of a data model in a data analytics computing system.

### BACKGROUND

The term database refers to an organized collection of data, stored and accessed electronically by way of a computing system. A database management system (DBMS) in turn is a computer program that provides an interface between the database and one or more end users so as to facilitate the interaction by each end user with the database. A DBMS generally also provides an interface to other computer programs to access the data in the underlying database. Generally speaking, end users and other computer programs interact with the database through the DBMS using query directives formed in conformance with a corresponding query language such as the venerable structured query language (SQL).

While the very basic use of SQL to query and manage data in a database is of no great difficulty for many end users, formulating more complex SQL queries is not for the faint of heart. More importantly, specifying a query irrespective of the mechanics of the actual query requires a strong understanding of the data in the database and the underlying relationships between the data. To the extent that “reading” the content of a database is not practical, it is known to model a database so that the created database model can then be introspected so as to afford a deeper understanding of the data in the database. Indeed, modern data analytics tools permit not only the modeling of an existing database, but also the formulation of SQL queries to be executed against the database based upon knowledge only supplied by the model.

In this regard, a data model is an abstract model that describes how a data set of a database is organized and guides the construction of queries with respect to the data of the data set. The data model generally contains a join graph whose vertices each reference a table and whose edges reflect join conditions between references to the tables. As well, the join graph may also describe the columns in those tables, columns that are derived from other columns via expressions, collections of columns by which queries are typically sorted, collections of columns by which queries are typically grouped into sub-totals and totals, expressions that are derived by combining column values during the construction of a sub-total or total, and other suggestions for how queries might be formed on the data.

Generating a data model can be a time consuming and difficult task, requiring specialized knowledge in describing different desired views for data in an underlying database. Great advancements in recent times have reduced some of this burden, but maintaining a model over time can still be quite challenging for many. Part of maintaining a model is the extension of the model. In this regard, instead of defining a new model for each instance of a data analytical exercise, an existing model may be extended, generally by augmenting the underlying meta-description of the content of the model. Because extensions can be applied ad hoc over time, and in light of the way in which the various pieces of a data model are organized into files, for even the most expert end user, it can be difficult to anticipate the final output of an extended data model. Further, with the ability to import remotely disposed content it becomes even more difficult to maintain an awareness of all components contributing to an extended data model.

### SUMMARY

Aspects of the present disclosure address deficiencies of the art in respect to extending a data model and provide a novel and non-obvious method, system and computer program product for the lightweight extension of a data model. In an example of the disclosure, a method for the lightweight extension of a data model includes first loading into memory, an extension document referencing a model document in a data analytics system. The model document defines a data model and the extension document extends the data model with at least one modification to the data model. The method then includes extracting from the extension document, the modification to the data model. Finally, the method includes creating in the memory the data model from the model document combined with the modification so as to produce an extension to the data model without processing a redeclaration of a view of the data model in the extension document.

This aspect of the disclosure may include one or more of the following optional features. In one aspect of the disclosure, the modification is an addition to the data model of a new dimension not previously defined in the data model of the model document. In another aspect of the disclosure, the modification is a removal from the data model of an existing dimension previously defined in the data model of the model document. In yet another aspect of the disclosure, the modification is a change to the data model of an existing dimension previously defined in the data model of the model document.

In another disclosure of the disclosure, a data processing system may be adapted for lightweight extension of a data model. The system can include a host computing platform that has one or more computers, each with memory and at least one processor. The system also includes a lightweight extension module. The module includes computer program instructions enabled while executing in the host computing platform to perform operations. One operation includes loading into the memory, an extension document referencing a model document in a data analytics system, with the model document defining a data model and the extension document extending the data model with at least one modification to the data model. Another operation includes extracting, from the extension document, the modification to the data model. Yet another operation includes creating in the memory, the data model from the model document combined with the modification so as to produce an extension to the data model without processing a redeclaration of a view of the data model in the extension document.

This aspect of the disclosure may include one or more of the following optional features. In one aspect of the disclosure, the modification is an addition to the data model of a new dimension not previously defined in the data model of the model document. In another aspect of the disclosure, the modification is a removal from the data model of an existing dimension previously defined in the data model of the model document. In yet another aspect of the disclosure, the modification is a change to the data model of an existing dimension previously defined in the data model of the model document.

Another aspect of the disclosure includes a computer program product for lightweight extension of a data model. The computer program product includes a computer readable storage medium having program instructions embodied therewith. The program instructions are executable by a device to cause the device to perform operations. One operation includes first loading into memory, an extension document referencing a model document in a data analytics system. The model document defines a data model and the extension document extends the data model with at least one modification to the data model. Another operation includes extracting from the extension document, the modification to the data model. Yet another operation includes creating in the memory the data model from the model document combined with the modification so as to produce an extension to the data model without processing a redeclaration of a view of the data model in the extension document.

This aspect of the disclosure may include one or more of the following optional features. In one aspect of the disclosure, the modification is an addition to the data model of a new dimension not previously defined in the data model of the model document. In another aspect of the disclosure, the modification is a removal from the data model of an existing dimension previously defined in the data model of the model document. In yet another aspect of the disclosure, the modification is a change to the data model of an existing dimension previously defined in the data model of the model document.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is pictorial illustration of a process for lightweight extension of a data model;

FIG. 2 is a schematic diagram of a data analytics data processing system adapted for lightweight extension of a data model; and,

FIG. 3 is a flow chart illustrating a process for the lightweight extension of a data model.

Like reference symbols in the various drawings indicate like elements.

### DETAILED DESCRIPTION

Aspects of the disclosure provide for the lightweight extension of a data model. In accordance with an example of the disclosure, an extension to a data model may be defined in two parts: by referencing the data model within the extension and by including in the extension, at least one modification to the data model. Each modification may add a new dimension to the data model, remove an existing dimension from the data model, or change a value within an existing dimension of the data model. Importantly, the extension itself need not redefine a view for the data model and merely references an identity of the data model and provides the modification or modifications. In this way, a data model may be extended without requiring a complete re-specification of the data model and the extensions to the data model may be reflected not in the model document of the data model itself, but in one or more extensions so as to compartmentalize changes to the data model and facilitate data model management over the lifecycle of the data model.

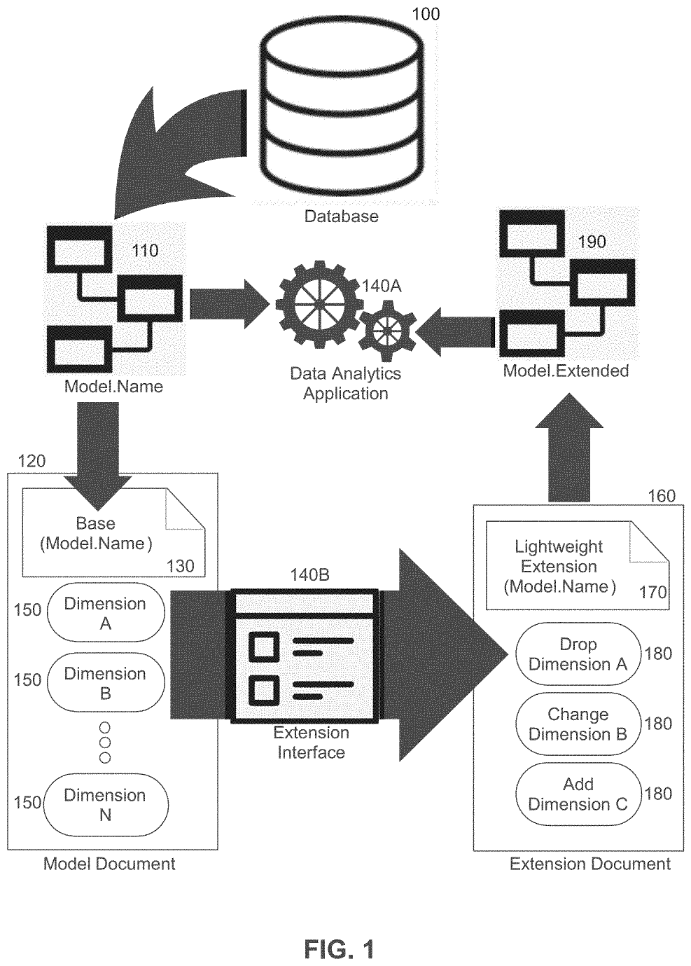

In a further illustration, FIG. 1 pictorially shows a process for lightweight extension of a data model. As shown in FIG. 1, a data model 110 for data in a database 100 can be defined and persisted within a model document 120. The model document 120 can specify one or more dimensions 150 and can include a name member 130 naming the data model 110. A data analytics application 140A then manages queries against the data model 110 including generating one or more visualizations of data within the data model 110. A user interface 140B is presented in connection with the data analytics application 140A providing a display of the different dimensions 150 of the data model document 120.

The user interface 140B also permits a manipulation of the different dimensions 150 of the data model document 120 including changing values for selected ones of the different dimensions 150, adding new dimensions from the database 100, and deleting existing ones of the dimensions 150 from the data model document 120. The user interface 140B then includes a user interface control (not shown) enabled to persist the changes to the data model document 120 in a separate extension document 160. In this regard, the extension document 160 can include a reference 170 to the data model document 120, and one or more directives 180 to modify the dimensions 150 of the data model document 120, including removing or dropping an existing one of the dimensions 150, changing an existing one of the dimensions 150 and adding a new dimension.

The data analytics application 140A then processes the extension document 160 by applying the changes therein to the referenced data model document 120 in order to produce an extended model 190. The data analytics application 140A then processes data queries against the extended data model 190 as defined by the data model 110 modified according to the directives 180 of the extension document 160. Consequently, the data model 110 can be extended in a lightweight manner without requiring a complete redefinition of a data model that includes elements of the original data model 110 and the changes set forth in the extension document 160, and thereby providing a less difficult mode of managing the lifecycle of the data model 120 and recognizing different changes over time to the data model 120 in reference to one or more instances of the extension document 160.

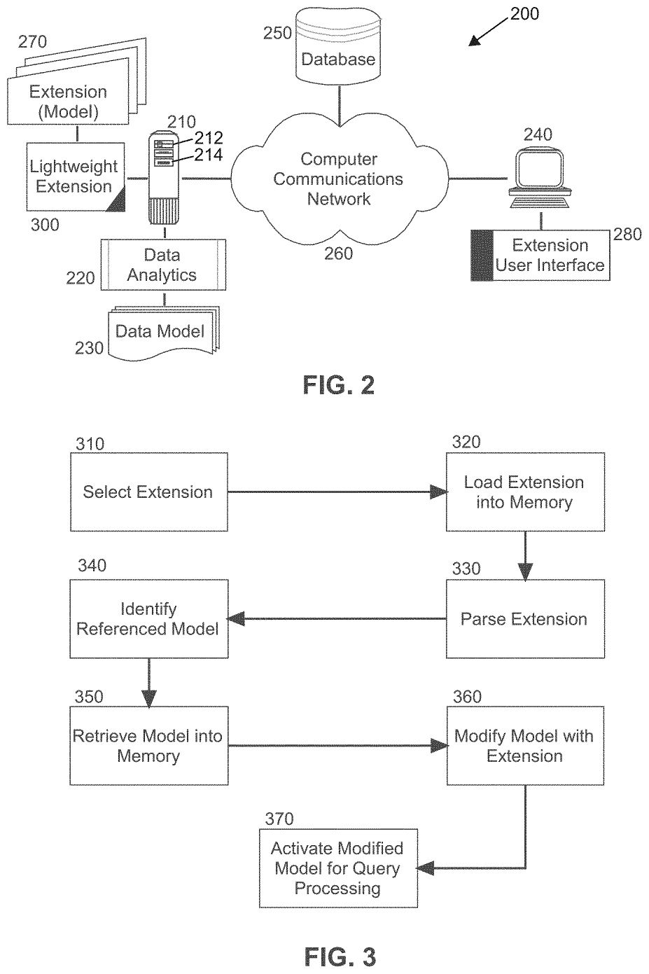

The process described in connection with FIG. 1 may be implemented in a data analytics data processing system 200. In further illustration, FIG. 2 schematically shows a data analytics data processing system 200 adapted for lightweight extension of a data model. The system 200 includes a host computing system 210 of one or more servers, each with memory hardware 212 and at least one processor 214, communicatively coupled over computer communications network 260 to one or more client computers 240 and to a database 250. A data analytics application 220 executes in the memory hardware 212 of the host computing platform 210 and provides a user interface in which one or more data models 230 for data in the database 250 are defined and against which different queries are conducted to produce one or more corresponding visualizations.

Of import, a lightweight extension module 300 includes computer program instructions operable during execution in the host computing platform 210, to extend the dimensions of different ones of the data models 230 in corresponding extensions 270. The program instructions additionally are enabled to provide an extension user interface 280 for display in the client computer 240 in which the dimensions of a selected one of the data models 230 is displayed and through which one or more changes to the selected one of the data models 230 is defined, including changing a value for a selected one of the dimensions, dropping an existing one of the dimensions, and adding a new dimension. The program instructions yet further are enabled to persist the changes specified in the extension user interface 280 in a corresponding one of the extensions 270.

Thereafter, the program instructions may process one of the extensions 270 by locating a referenced one of the data models 230 and applying the changes in the one of the extensions 270 to the referenced one of the data models 230 in order to produce an extended data model in the memory hardware 212 of the host computing platform 210. Such changes include the addition of one or more dimensions to the referenced one of the data models 230, the removal from the referenced one of the data models 230 of one or more dimensions, and the modification within the referenced one of the data models 230 of one or more dimensions. Finally, the data analytics application 220 can process queries against the extended data model in the memory hardware 212 of the host computing platform 210.

In another illustration of the operation of the lightweight extension model 300, FIG. 3 is a flow chart illustrating a process for the lightweight extension of a data model. Beginning in block 310, an extension document is selected for loading in the data analytics application 140A and in block 320, the extension document 160 is loaded into memory 212. In block 330, the content of the extension document 160 is parsed and in block 340, an identification of a data model 110 extended by the extension document 160 is extracted. Then, in block 350, a data model document 120 for the referenced data model 110 is retrieved from fixed storage 100 and loaded into memory 212. In block 360, the directives 180 of the extension document 160 are applied to the data model 110 of the data model document 160 including any or all of modifying an existing dimension 150, adding a new dimension and dropping an existing dimension 150. The application of the directives 180 of the extension document 160 produce an extended data model. Finally, the extended data model 190 is activated for use in the data analytics application 140A.

The present disclosure may be embodied within a system, a method, a computer program product or any combination thereof. The computer program product may include a computer readable storage medium or media having computer readable program instructions thereon for causing a processor to carry out aspects of the present disclosure. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present disclosure are described herein with reference to flowchart illustrations and/or block diagrams of methods, apparatus (systems), and computer program products according to aspects of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the present disclosure. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “include”, “includes”, and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The example was chosen and described in order to best explain the principles of the disclosure and the practical application, and to enable others of ordinary skill in the art to understand the disclosure for various aspects with various modifications as are suited to the particular use contemplated.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method for the lightweight extension of a data model, when executed by data processing hardware causes the data processing hardware to perform operations comprising:
loading into memory, an extension document referencing a model document in a data analytics system, the model document defining a data model and the extension document extending the data model with at least one modification to the data model;
extracting from the extension document, the at least one modification to the data model; and
creating in the memory, the data model from the model document combined with the at least one modification so as to produce an extension to the data model without processing a redeclaration of a view of the data model in the extension document.

2. The method of claim 1, wherein the at least one modification is an addition to the data model of a new dimension not previously defined in the data model of the model document.

3. The method of claim 1, wherein the at least one modification is a removal from the data model of an existing dimension previously defined in the data model of the model document.

4. The method of claim 1, wherein the at least one modification is a change to the data model of an existing dimension previously defined in the data model of the model document.

5. A data processing system adapted for lightweight extension of a data model, the system comprising:
a host computing platform comprising one or more computers, each comprising memory and at least one processor; and
a lightweight extension module comprising computer program instructions enabled while executing in the host computing platform to perform operations comprising:
loading into the memory, an extension document referencing a model document in a data analytics system, the model document defining a data model and the extension document extending the data model with at least one modification to the data model;
extracting from the extension document, the at least one modification to the data model; and
creating in the memory, the data model from the model document combined with the at least one modification so as to produce an extension to the data model without processing a redeclaration of a view of the data model in the extension document.

6. The system of claim 5, wherein the at least one modification is an addition to the data model of a new dimension not previously defined in the data model of the model document.

7. The system of claim 5, wherein the at least one modification is a removal from the data model of an existing dimension previously defined in the data model of the model document.

8. The system of claim 5, wherein the at least one modification is a change to the data model of an existing dimension previously defined in the data model of the model document.

9. A computer program product for lightweight extension of a data model, the computer program product including a computer readable storage medium having program instructions embodied therewith, the program instructions executable by a device to cause the device to perform operations comprising:
loading into memory, an extension document referencing a model document in a data analytics system, the model document defining a data model and the extension document extending the data model with at least one modification to the data model;
extracting from the extension document, the at least one modification to the data model; and
creating in the memory, the data model from the model document combined with the at least one modification so as to produce an extension to the data model without processing a redeclaration of a view of the data model in the extension document.

10. The computer program product of claim 9, wherein the at least one modification is an addition to the data model of a new dimension not previously defined in the data model of the model document.

11. The computer program product of claim 9, wherein the at least one modification is a removal from the data model of an existing dimension previously defined in the data model of the model document.

12. The computer program product of claim 9, wherein the at least one modification is a change to the data model of an existing dimension previously defined in the data model of the model document.
